(19) United States
(12) Patent Application Publication
(10) Pub. No.: US 2018/0300623 A1
(43) Pub. Date: Oct. 18, 2018

(54) MULTIFACTOR VENUE LOCALIZATION USING CENTRALIZED LEARNING

(71) Applicant: Microsoft Technology Licensing, LLC, Redmond, WA (US)

(72) Inventors: Zhengyou Zhang, Bellevue, WA (US); Dinei Afonso Florencio, Redmond, WA (US); Sasa Junuzovic, Kirkland, WA (US); Yinpeng Chen, Sammamish, WA (US)

(21) Appl. No.: 15/489,234

(22) Filed: Apr. 17, 2017

(51) Int. Cl. G06N 3/08; G06F 17/30

(52) U.S. Cl. CPC G06N 3/08; G06F 17/30979

(57) ABSTRACT

A central server receives a venue identification query from a client device in the venue and a test data set including information collected from the venue. The central server then queries a classifier to identify the venue based on the test data. The classifier returns an identity value (venue ID) and a confidence value for the venue ID. When the confidence value is less than a threshold value, the central server obtains additional data from the client device until the venue is identified. The central server associates the venue ID with the test data set, including the additional data, and adds the test data set to training data for the classifier.

### BACKGROUND

Data sharing in group meetings can be facilitated by automatically informing any joining participants of connection information for the meeting based on the meeting venue.

### SUMMARY

This summary is not an extensive overview of the claimed subject matter. It is intended to neither identify key elements of the claimed subject matter nor delineate the scope of the claimed subject matter. Its sole purpose is to present some concepts of the claimed subject matter in a simplified form as a prelude to the more detailed description that is presented later.

In one embodiment, a central server receives a venue identification query from a client device in the venue and a test data set including information collected from the venue. The central server then queries a classifier to identify the venue based on the test data. The classifier returns an identity value (venue ID) and a confidence value for the venue ID. When the confidence value is less than a threshold value, the central server obtains additional data from the client device until the venue is identified. The central server then transmits connection information associated with the obtained venue ID to the client device. Next, the central server associates the venue ID with the test data set, including the additional data, and adds the test data set to training data for the classifier.

In another embodiment, a client device in a venue obtains connection information for an event in the venue by collecting ambient data from the venue and transmitting the collected data to a central server with a request for the connection information. The client device then receives a request for additional data to identify the venue from the central server. In response to the request, the client device generates additional data identifying the venue and transmits the additional data to the central server. The client device repeats this process until the client device receives the requested connection information from the central server.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description when considered in conjunction with the drawings.

### BRIEF DESCRIPTION OF THE DRAWINGS

FIGS. 1A and 1B are cut-away top-plan drawings showing conference venues;

FIG. 2 is a block diagram of an example system in which multiple conference venues communicate with a central server;

FIG. 3 is a block diagram of an example of a conference venue system;

FIG. 4 is a block diagram of an example client device;

FIG. 5 is a signaling chart illustrating an example operational scenario;

FIGS. 6A and 6B are flow-chart diagrams illustrating example applications configured to run on client devices.

FIGS. 7A and 7B are flow-chart diagrams illustrating example applications configured to run on a central server device.

### DETAILED DESCRIPTION

As a preliminary matter, some of the figures describe concepts in the context of one or more structural components, variously referred to as functionality, modules, features, elements, or the like. The various components shown in the figures can be implemented in any manner, such as software, hardware, firmware, or combinations thereof. In some cases, various components shown in the figures may reflect the use of corresponding components in an actual implementation. In other cases, any single component illustrated in the figures may be implemented by a number of actual components. The depiction of any two or more separate components in the figures may reflect different functions performed by a single actual component.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, and/or custom logic components such as field programmable gate arrays (FPGAs), application specific integrated circuits (ASICs), programmable logic arrays (PLAs) or the like.

As to terminology, the phrase “configured to” encompasses any way that any kind of functionality can be constructed to perform an identified operation. The functionality can be configured to perform an operation using, for instance, software, hardware, firmware, or the like. For example, the phrase “configured to” can refer to a logic circuit structure of a hardware element that is arranged to implement the associated functionality. The phrase “configured to” can also refer to a logic circuit structure of a hardware element that is arranged to implement the coding design of associated functionality of firmware or software. The term “module” refers to a structural element that can be implemented using any suitable hardware (e.g., a processor, among others), software (e.g., an application, among others), firmware, and/or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any non-transitory computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

The following describes apparatus and methods for automatically connecting client devices to an on-line conference and/or to a local collaboration by connecting to other electronic equipment in a conference venue. The examples below describe a conference and a conference venue. As used herein, the term “conference” relates to any multi-party communication either local to the conference venue or with participants remote from the conference venue including both interactive (e.g. web conference, application sharing, multi-participant on-line game, peer-to-peer conference, etc.) and non-interactive (e.g. multicast presentation, screen sharing, web streaming service, etc.) In the examples described below, a client device requests the connection information from a central server upon entering a venue. To satisfy the request, the central server attempts to identify the venue using ambient information collected from the venue by the client device. When the central server cannot identify the venue based on the ambient information, it requests and obtains additional information, which may include a ground truth identification of the venue, from the client device or devices. Once the central server has identified the conference venue with sufficient certainty, it sends connection information for the on-line conference or collaboration to the client device or devices. The central server then associates the determined venue identifier (ID) with the collected data and adds the combined data to training data used by a classifier to identify the venue.

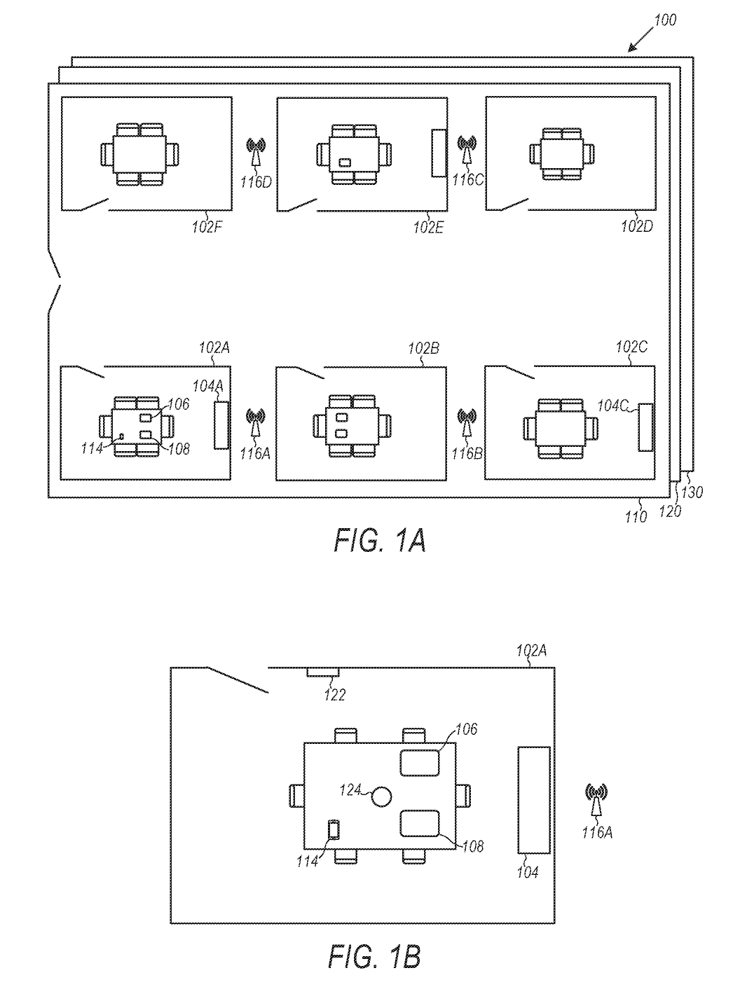

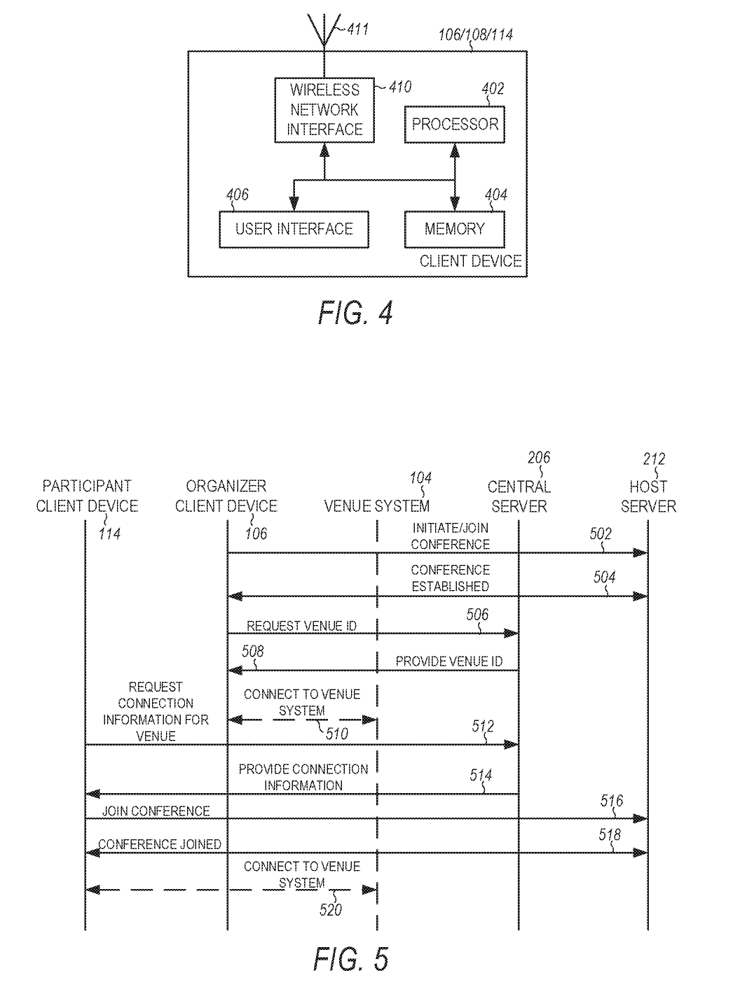

FIG. 1 is a cut-away top-plan view of a building 110 that is one of several buildings 110, 120, 130 used by an enterprise 100. As shown, the building 110 includes multiple conference rooms, 102A, 102B, 102C, 102D, 102E and 102F. While the description below refers to conference rooms, it should be understood that other venues including indoor and outdoor locations, such as theatres, hallways, common spaces, courtyards, construction sites, etc. are also contemplated. The building also includes multiple Wi-Fi access points, 116A, 116B, 116C and 116D. Each conference room may or may not include a local conference room system 104 which, for example, includes a display system and an audio system. In the example building 110, rooms 102A, 102C and 102E have conference room systems 104A, 104C and 104E, respectively, while rooms 102B, 102D and 102F do not have conference room systems. As described below with reference to FIG. 3, the conference room system 104 may include display devices, sound systems, environmental controls (lighting, HVAC, etc.) and computing and communications hardware used to control Internet of Things (IoT) appliances in the room.

Conference participants may join the conference or collaboration using client devices such as portable computers 106 and 108 or smart phones 114. These devices may connect to a wireless local area network (WLAN) using the access points 116A, 116B, 116C and 116D. The WLAN may, in turn, be coupled to a larger, wide area network (WAN), such as an enterprise intranet or to global data network (e.g. the Internet). The portable computers and smart phones shown in FIG. 1A are not meant to be limiting. Client devices include other types of devices having wireless communications capabilities such as desktop computers or other types of portable computers such as tablet computers, Personal Digital Assistants (PDAs) or wearable computers. Furthermore, although FIG. 1A shows only Wi-Fi (IEEE 802.11) access points, it is contemplated that other types of wireless communications protocols may be used to access the WLAN including Bluetooth®, NFC and/or ZigBee (IEEE 802.15), for example. Alternatively or in addition, systems relying on ultrasonic and/or infrared technologies may be used to connect to the WLAN.

In a one type of conference, one member, the conference organizer, may use the WLAN to sign on to a web site having tools that allow the member to see other conference participants and share images and/or digital documents. Other users, either in the conference room or at remote sites may join the conference by accessing the same web site. When the conference room includes a conference room system 104, the conference organizer or other participant may cause the desktop of their client device to be displayed on the conference room system 104. Alternatively, the conference room system 104 may be configured to display images of the conference participants who are not physically in the meeting room. In another type of conference, participants may not connect to an external server or to remote participants but may share screens and/or data in a local collaboration within the venue. In this type of conference, all participants may be linked to the conference room system 104 to be able to share screens with all participants.

FIG. 1B is a top-plan view of the conference room 102A shown in FIG. 1A. The conference room 102A includes all of the elements described above with reference to FIG. 1A and also includes environmental controls 122 and an ultrasonic transducer 124. In this example, the environmental controls 122 are IoT devices that may be controlled using the conference system 104 and that may provide status information (e.g. lighting level and ambient temperature) to the conference system 104 or to the client devices in the venue. In conference rooms without a conference system 104, the IoT environmental controls 122 may be accessed by any meeting participant having the Internet Protocol (IP) address of the controls 122.

The example transducer 124 may be an IoT device that emits an ultrasonic code identifying the conference room 104A. The transducer 124 may be programmed to emit a unique code that identifies the venue 104A over the entire enterprise. Alternatively, the emitted code may identify the venue 104A more locally, for example, in the building or on the particular floor of the building. The transducer 124 may be configured to emit the venue ID either continuously or in response to an electronic or ultrasonic command. In this implementation, the transducer 124 emits the ultrasonic in a frequency range that is inaudible to humans, for example, above 22 KHz. The ultrasonic venue ID signal emitted by the transducer 124 may be received by microphones of the portable computers 106 and 108 and smart phone 114. The client devices 108, 108 and 114 may digitize and process the signal to extract the venue ID. Alternatively, they may send the digitized signal and/or a frequency decomposition (e.g. fast Fourier transform (FFT)) of the signal to the central server which may process the signal to extract the venue ID.

Although some of the examples described below use an ultrasonic transducer, such as the transducer 124, to identify the venue, it is contemplated that other type of devices may be used for a similar purpose. For example, the room lighting may be configured to emit visible light communication (VLC) signals. These signals may identify the venue or the light fixture. These VLC signals may be captured by video cameras in the portable computers 106 and 108 or in the smart phone 114 and decoded in the device 106, 108 or 114 before being transmitted to the central server, as described below, as part of the ambient data or the additional data.

In this example, three users attend the conference using portable computers 106 and 108 and smart phone 114. In this example, the conference organizer, using portable computer 106 initiates the conference by accessing a web site or establishing a link to the conference room system 104. The organizer's desktop is shared with the conference room system 104 such that images of the local and/or remote conference participants are displayed on the display system of the conference room system 104. The users of the portable computer 108 and smart phone 114 need to know the uniform resource locator (URL) or IP address of the web site in order to join the conference. While the organizer can provide this information manually, it would be helpful if the participants in the room could automatically determine the address and access the conference without having to manually enter the web site address.

In one example described below, an organizer starts a conference and sends the web site address and/or local collaboration information to the central server along with ambient data collected from the venue. The central server inputs the ambient data as a test data set to a classifier in order to identify the venue and, upon identifying the venue, associates the web site address with the venue ID. A participant who wants to connect to the conference and/or collaboration also collects ambient data from the venue and transmits it to a central server. The central server, again uses the classifier to identify the venue based on the ambient test data received from the participant and, when the venue has been identified, transmits the web site address associated with the venue ID to the participant. The participant then uses this address to join the conference and/or collaboration.

A problem may arise, however, when the classifier cannot identify the venue based on the test data set provided by either the organizer or the participant. In this instance, the central server may request additional data. This additional data may be additional ambient data collected from the venue or it may be a venue ID provided by a device in the venue, such as the transducer 124. Alternatively, the additional data may be a ground truth venue ID input by the organizer or the participant.

The central server then either records the room identifier provided by the organizer or participant client device or adds the additional data to the test data set and applies the augmented test data to the classifier to determine whether there is sufficient data to identify the venue.

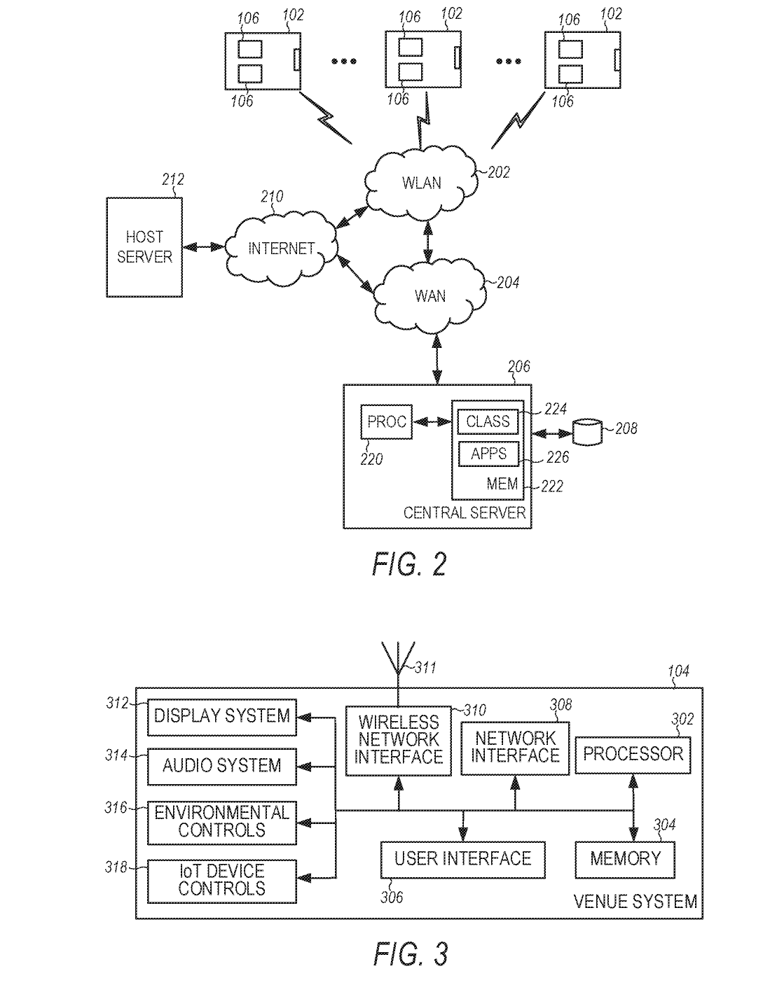

FIG. 2 is a block diagram of an example enterprise system 200 in which one or more of the described automatic venue identification methods or systems may be implemented. As shown, multiple venues 102 include client devices 106 that communicate with a WLAN 202. The WLAN 202, in turn, communicates with a WAN 204. The organizer or participant may communicate with the central server 206 through the WLAN 202 and/or the WAN 204. The WAN 204 may be an enterprise WAN for the company or it may be the Internet. When the WAN 204 is an enterprise WAN, it may be connected to the Internet 210. The host server 212 in FIG. 2 is a server to which the organizer connects for initially establishing or joining the conference. When the WAN 204 is the Internet, the connections to the Internet 210 shown in FIG. 2 may, instead, connect to the WAN 204. As shown in FIG. 2, the WLAN 202 may connect to the Internet 210 directly or through the WAN 204.

The host server 212, for example, hosts a collaboration program such as Skype®, Microsoft Lync®, Google Hangouts®, or the like. When a conference session is established, the host server 212 sends connection information to the organizer. As described below, the organizer associates this connection information with the venue in a database 208 of the central server 206 and the participants automatically access the connection information by sending ambient test data and additional data to the central server 206.

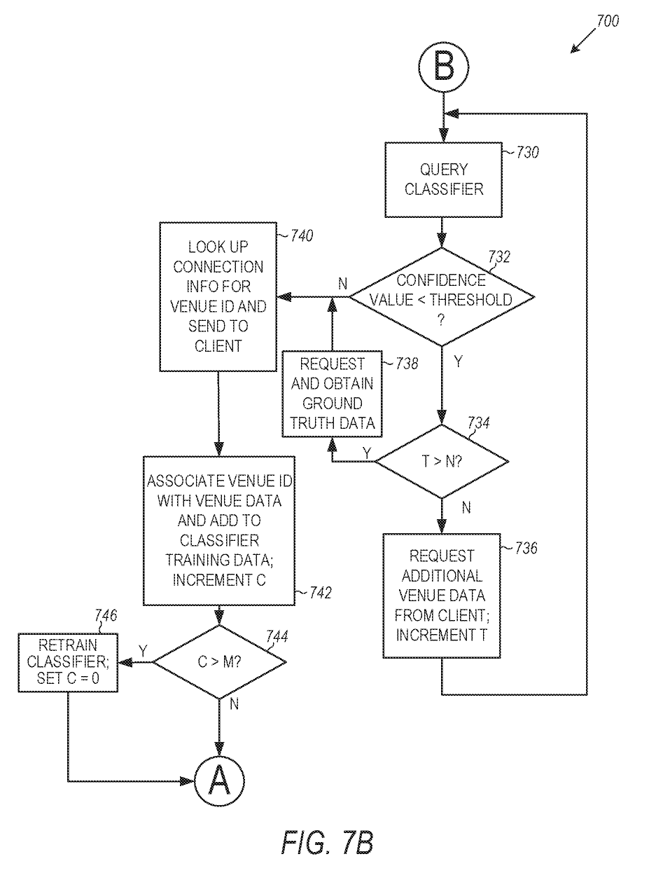

As shown in FIG. 2, in one implementation, a central server 206 includes a processor 220 and a memory 222. It may also include a network interface, an input/output interface (I/O), and a user interface (UI). For the sake of clarity the UI and I/O elements are not shown in FIG. 2. The memory 222 includes software modules that implement application programs (APPs) 226 and the classifier 224. In addition, the memory may hold the software for the operating system (not shown). One of the application programs is the program, described below with reference to FIG. 7, that identifies the venue 102 based on the ambient and additional data provided to the central server 206 by the client device 106, 108 and/or 114. Although the classifier 224 is shown as a software module of the central server 206, it is contemplated that it may be at least partially implemented using a separate hardware module, for example, a neural network (not shown). The classifier may also be implemented on a separate computer (not shown) that is accessed by the central server 206. It is also contemplated that the classifier may be remote from the central server 206 and accessed via the WAN 204 and/or Internet 210.

The classifier 224 in one implementation is a trained classifier that receives ambient data from each organizer and/or each participant client device and returns data identifying the venue from which the organizer and/or participant client device collected the ambient data. The classifier 224 may include a neural network, a hidden Markov model (HMM), a Gaussian mixture model (GMM) and/or a support vector machine (SVM). In an implementation using an SVM, each ambient data set includes a feature vector having values corresponding to features extracted from the ambient data. Example features may include the frequency components and level of ambient audio in the venue, the identity (e.g. media access control (MAC) IDs) and strength of signals from Wi-Fi access points, such as the access points 116A-116D of FIG. 1, the identity and strength of Bluetooth beacons, identifying information for the client devices 106, 108 and/or 114 in the venue and/or the venue system 104 the time zone information from the client device used by the organizer or participant, the venue temperature, the lighting level in the venue and/or other environmental data. The feature vector may also include meeting location data in a current calendar entry for the client device, global navigation satellite system (GNSS) data or other location data collected by the client device and the elapsed time since it was collected, In the training mode, each ambient data set (e.g. feature vector) is labeled with the venue from which it was collected.

The SVM builds a multi-dimensional model, where each dimension corresponds to a feature in the feature vector. The SVM then analyzes the data to partition the multi-dimensional space (also known as a hyperplane) into regions corresponding to the respective venues. When a new test feature vector is available, it is mapped into one of the partitions to determine its corresponding venue. The partition identifies the venue and the amount of separation, also known as the degree of closeness, between the test feature vector and other feature vectors in other partitions corresponding to other venues provides a confidence value for the test. The degree of closeness is inversely proportional to the confidence value.

In a GMM, each feature in the feature vector corresponds to a point in a Gaussian distribution. The GMM is trained by obtaining frequency distributions of each feature in the feature vector and using the frequency distributions to model respective Gaussian distributions for each feature. As new test data sets are received, a probability value is generated for each feature and the probabilities are combined to determine which venue is the most likely. The probability that a feature vector corresponds to a particular venue also serves as a confidence value.

In implementations in which the classifier is a neural network, labeled feature vectors are processed by the network in a training mode to generate weighting values for the neurons. When a test data set is applied to the trained neural network, the output value indicates the venue determined by the network to correspond to the test vector. The confidence value for the neural network may be determined by measuring the error rate of previous tests.

An SVM or GMM used to classify a large number of venues may have a very large feature vector. For example, if one of the features is the signal strength of a particular access point, that access point may be present in every feature vector even though it is found in only one venue. Similarly, older features may not be found in newer test data sets because the equipment generating the feature is no longer present in the venue. Both SVMs and GMMs attempt to reduce the dimensionality of the spaces as a part of the algorithm. Essentially, during the training process, these algorithms selectively remove certain features from the feature vector and to determine the net effect of the feature on the classification. Less relevant features may be discarded to reduce the computational complexity.

Older features or less-frequently occurring features may also be discounted by applying weighting values that decrease as the feature ages and/or represent the frequency of occurrence of the feature. For example, when the collected ambient data includes GNSS or other location data from the client device and the elapsed time since the data was generated, the GNSS data may be weighted by a value that is inversely proportional to the elapsed time such that GNSS data having a shorter elapsed time receives more weight than GNSS data having a longer elapsed time.

In one example using an SVM as the classifier, the venue database may be generated dynamically. When, for example, an organizer first provides a test data set for a venue, the classifier may not be able to determine the venue ID corresponding to the test data set or may return a venue ID that the organizer knows to be erroneous. The organizer may provide the correct venue ID to the classifier which then associates the venue ID with the test data set to use as training data for the classifier. Similarly, when a participant receives an incorrect response to a test data set, the application program 226 running on the central server 206 may ask the participant to confirm that either the venue ID is correct or that the connection information is correct. When either of these is incorrect, the application may obtain additional data. This data may be the ground truth venue ID captured automatically from the venue or entered by the organizer and/or the participant or it may be further ambient data collected from the venue. The further ambient data may be additional data for the features captured in the test data or data corresponding to additional features that were not in the test data.

Alternatively, or in addition, the additional data may be data that uniquely identifies the venues, such as the audio venue ID emitted by the transducer 124 shown in FIG. 1B, a VLC identifier provided by a light fixture, and/or an image, such as a bar code, QR code or room number captured by the camera of one or more of the client devices 106, 108 or 114. In response to receiving this additional data, the application program 226 may again attempt to use the classifier to identify the venue. After a predetermined number of attempts, the application program may request ground truth data from the participant/organizer. This request may take the form of a question asked to the participant or organizer, asking that the venue ID be entered manually. When the additional information sufficiently identifies the venue, the application program 226 may return the connection information and/or venue ID to the client and label the test data set with the correct venue ID so that it may be added to the training data for the classifier. The accuracy of the classifier 224 increases as it is trained on more labeled data sets so that, eventually, the application program 226 will only rarely provide incorrect connection information and/or venue IDs or be unable to identify the venue with sufficient certainty.

Similarly, when the confidence value for the venue ID is less than a threshold value, for example 50% to 70%, the application program 226 may automatically request and process the additional data, as described above, rather than provide possibly incorrect connection and/or venue ID data to the client devices 106, 108 and/or 114. While the confidence value is described as a probability, it may take other forms. For example, when the classifier determines that the venue ID is sufficiently likely (e.g. 60%-100%) it may send only the determined venue ID which the participant device will interpret as a confidence value sufficient to identify the venue.

FIG. 3 is a block diagram of an example venue system 104. The venue system 104 includes a processor 302, memory 304, user interface 306, physical network interface 308, wireless network interface 310 including antenna 311, display system 312, audio system 314, environmental controls 316 (e.g. lighting, HVAC, etc.) and IoT device controller 318. The physical network interface 308 may couple the venue system 104 to an optical or wired network in the building 110. The wireless network interface may include one or more of a Wi-Fi transceiver, a ZigBee transceiver, a Bluetooth transceiver, an NFC transceiver, an optical (e.g. infrared) transceiver or an ultrasonic transceiver to provide short-range communications within and beyond the venue 104.

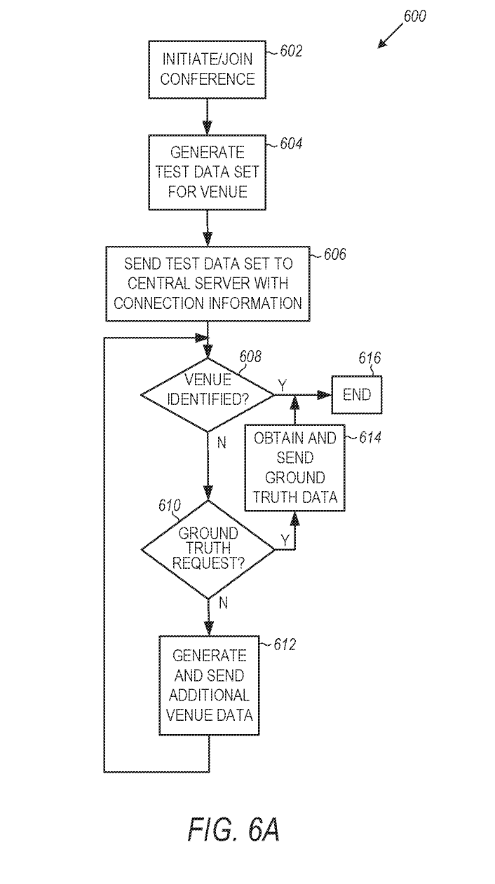

FIG. 4 is a block diagram of relevant components of an example client device such as the portable computers 106 and 108 or the smart phone 114. The client device includes a processor 402, memory 404, user interface 406 and wireless network interface 410, including antenna 411. The user interface for the portable computers 106 and 108 may include output devices such as a display, a microphone and a speaker and input devices such as a keyboard, pointing device, and/or touch screen. The user interface for the smart phone 114 may include a display, microphone, speaker and touch screen.

The memory 404 of each client device 106, 108 and 114 may include software that implements a service module (not separately shown) capable of communicating with venue system to facilitate conference sessions, such as online voice, video, and data conferences, with other service clients. Microsoft Lync, Skype, Google Hangouts, and Apple FaceTime are examples of service modules that may be used in an example venue system and associated client devices. In addition, the memory may include a module, such as an application program, that communicates with the central server 206 to automatically obtain connection information that allows the client device 106, 108 and/or 114 to connect to initiate or join a conference and/or collaboration from the venue 102 or to automatically connect to a previously initiated conference and/or collaboration associated with the venue.

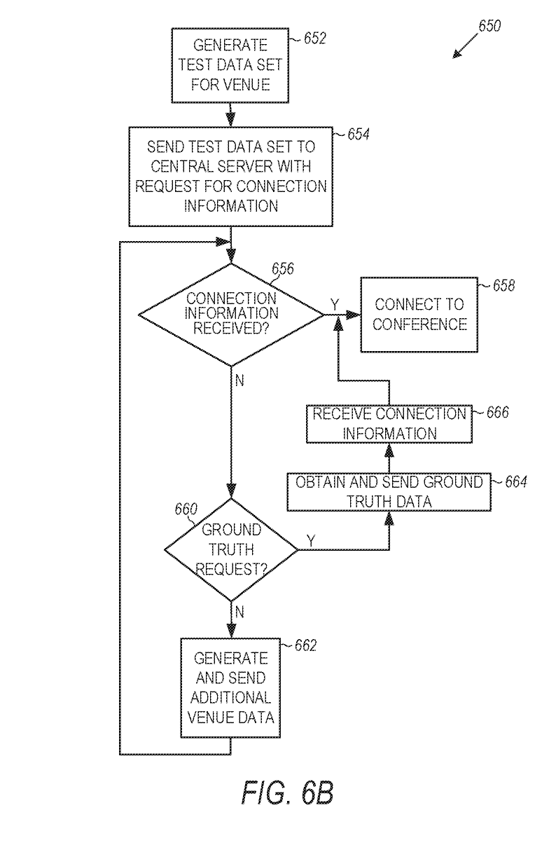

FIG. 5 is a signaling diagram for an example system that illustrates possible signal flows among the organizer client device 106, host server 212, central server 206, participant client device 114 and optional venue system 104. At 502, the organizer 106 initiates or joins a conference with remote participants using the conference software running on the host server 212. At 504, the organizer device 106 has initiated or joined the conference. At 506, the organizer client device 106 collects and sends ambient data as a test data set as well as connection information for the conference to the central server 206. At 508, when the central server 204 is able to identify the venue based on the test data, the central server 204 sends the venue ID to the organizer client device 106 for confirmation. When it is not able to identify the venue or when the organizer fails to confirm the venue ID, the central server 204 requests and receives the additional data as described below. Eventually, when the central server 204 identifies the venue, it sends the venue ID to the organizer client device 106. When the venue includes a venue system 104, the organizer device 106 may establish a connection with the venue system 104 at 510.

At 512, the application running on the participant client device 114 automatically collects ambient data from the venue and requests connection information for the conference initiated or joined by the organizer client device 106. At 514, when the central server 204 is able to identify the venue based on the test data, the central server 204 sends the venue ID to the participant. When it is not able to identify the venue, the central server 204 requests and receives the additional data as described below. Eventually, when the central server 204 identifies the venue, it sends the venue ID to the participant client device 114 at 514. At 516 the participant joins the conference. At 518 the participant client device 114 and the organizer client device 106 participate in the conference. At 520 the participant client device 106 may connect to the venue system 104 when it exists in the venue.

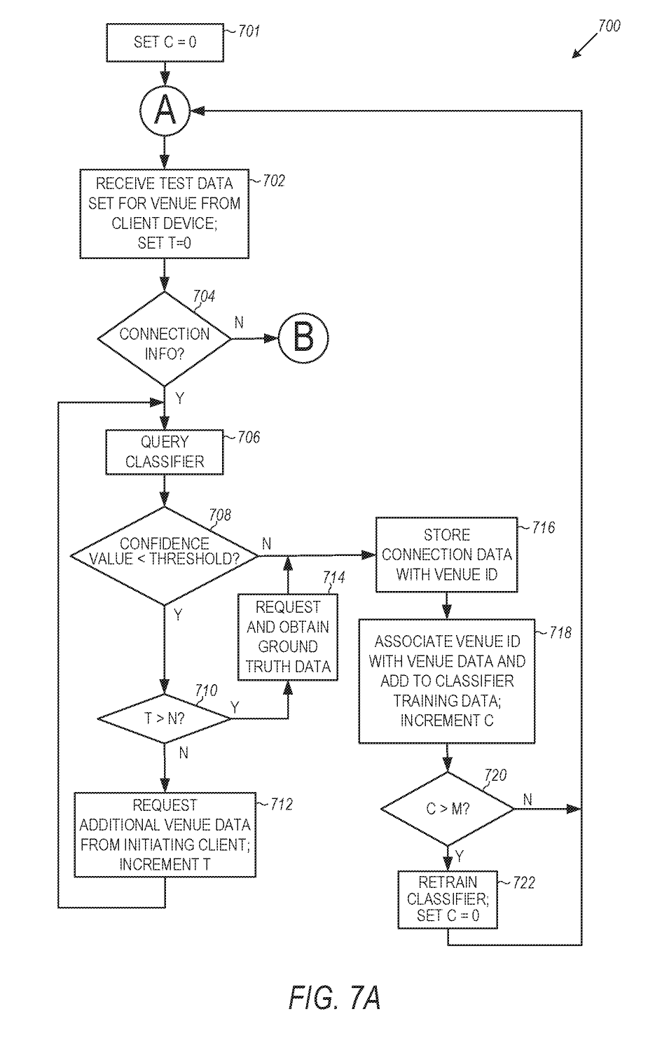

FIG. 6A is a flowchart diagram of an example application program 600 running on one of the client devices, 106, used by an organizer. At block 602, the organizer client device 106 initiates or joins a conference and/or local collaboration. The organizer client device 106 generates the test data set for the venue at block 604, As described above, the test data for the venue may be generated by obtaining identities (e.g. MAC IDs) and signal strengths of Wi-Fi access points and/or Bluetooth devices to obtain a radio-frequency (RF) fingerprint of the venue, alternatively or in addition, the organizer client device 106 may obtain other environmental information (e.g. audio frequency spectrum and amplitude, lighting levels, ambient temperature, etc.) concerning the venue. The test data set may also include information extracted from the client device such as location data from a current calendar entry, GNSS or other location data and the elapsed time since the location data was generated, the current time, the current status of the client device and/or image data captured by a camera of the client device. At block 606, the organizer sends the test data set to the central server 206 with the connection information for the conference and/or collaboration.

At block 608 the organizer client device 106 receives a response from the central server 206. When this response indicates that the venue has been identified, the application 600 ends at block 616. When, at block 608 the venue has not been identified, the application 600 executes block 610 to determine whether the response from the central server 206 included a ground truth request. As described below with reference to FIG. 7, the central server 206 generates a ground truth request when it is unable to identify the venue based on the test data set and a predetermined number, N, of additional data sets. Request for ground truth is a request for organizer to identify the venue either manually or automatically using apparatus or features in the room that provide a unique venue ID.

When the response from the central server 206 does not include a ground truth request, the application 600, at block 612, generates and sends additional venue data to the central server 206. After block 612, control branches to block 608 to determine whether a message has been received from the central server 206 indicating that the venue has been identified. The application 600 ends, at block 616, when either the central server 206 has identified the venue at block 608 or has requested and received a ground truth venue ID at block 614.

FIG. 6B is a block diagram of an example application 650 that may be run by a participant client device 114. The participant client device 114, upon entering the venue, initiates the application 650. At block 652, the application collects test data for the venue as described above with reference to FIG. 6A. At block 654, the application sends the test data to the central server 206 with a request for connection information to connect the participant client device 114 to the conference and/or collaboration. The application 650 determines whether the central server 206 identified the venue based on the test data set at block 656 and sent the connection information to the participant client device 114. When the client device 114 has received the connection information it connects to the conference and/or collaboration automatically at block 658. When the application 650 has not received the connection information at block 656, it determines whether the central server 206 has sent a ground truth request at block 660. If a ground truth request has not been received, the application continues to block 662 and the process 650 generates and sends additional venue data to the central server 206.

As described above, the central server issues a ground truth request when it is unable to identify the venue from the test data set and N additional ambient data sets collected by the process 650. When the process 650 has received a ground truth request, it obtains the ground truth data, as described above with reference to FIG. 6A, and sends the ground truth data to the central server 206 at block 664. In response, to the central server sends the connection information to the participant client device 114 at block 666. At block 658 the participant client device 114 has received the connection information from the central server 206 either because the central server 206 identified the venue based on the test data set and ambient data sets or because the server 206 identified the test venue based on the ground truth data. At block 658, the participant client device 114 automatically connect to the conference and/or collaboration.

FIGS. 7A and 7B together are a flowchart diagram of an example application 700 that may run on the central server 206 and that is complementary to the applications 600 and 650 running on the client devices 106 and 114. The application 700, at block 701, sets a variable C to zero. The variable C is used to count the number of classification operations performed by the classifier 224. At block 702 the application 700 receives a test data set for a venue from a client device and sets a variable T to zero. The variable T is used to count the number of data sets processed by the classifier for a particular client device to provide the current venue ID to the client device. At block 704, the application determines whether the test data set was accompanied by connection information. As described above, the organizer client device sends this test data set with information for connecting to a previously initiated or joined conference and/or information identifying the organizer client device and/or the venue system 104 that will allow the participant client device to connect to the local collaboration. The participant client device sends a request for connection information. When, at block 704 the application receives connection information, the test data set is from the organizer client device. At block 706, the application 700 running on the server 206 queries the classifier 224 with the test data set to determine whether the test data is sufficient to identify the venue. At block 706, the classifier 224 returns the venue ID and a confidence value. The application 700, at step 708, determines whether the confidence value is less than a threshold value.

When the confidence value is less than the threshold value at block 706, the application 700 cannot identify the venue. Next, at block 710, the application 700 determines whether the value T is greater than N indicating that the process has tried to identify the venue based on the test data set and additional ambient data more than N times. When T is less than or equal to N at block 710, block 712 requests additional venue data from the organizer client device and transfers control to block 706 which queries the classifier based on the combination of the test data set and the additional venue data. When, at block 710, T is greater than N, block 714 requests and obtains ground truth data from the organizer client device. The value N represents a maximum number of times that the application 700 attempts to collect additional ambient data from a particular client device in a particular venue. Because the collection of ambient data may take some time, N is desirably a small number (e.g. less than five). In other embodiments, additional data is sent by the client device even after a venue is identified. Such additional data may be used to help identify the venue for venue identification requests from future client devices.

The application 700 may request ground truth data by asking the organizer to manually input the venue ID. Alternatively the application 700 may cause the organizer client device to emit an audio signal which causes the transducer 124, shown in FIG. 1B to emit an audio signal containing the venue ID. The client device then collects the emitted venue ID and returns the venue ID to the central server 206. As another alternative, the application 700 may display the venue ID returned by the classifier and ask the organizer to indicate whether the venue ID is correct and, if not, enter the correct venue ID. In yet another alternative, the application 700 may prompt the organizer to capture an image of a QR code containing the venue ID. The QR code may be affixed to a wall, to a table or to another item in the venue.

At block 716, the application 700 has identified the venue either from the test data set, from the test data set in combination with one or more additional data sets, or from the ground truth data. At block 716, the application 700 stores the stores the connection data with the venue ID. At block 718, the process 700 associates the venue ID with the test data set and any additional venue data sets and adds the combined data set to the training data for the classifier 224. At block 720, the process 700 determines whether the variable C is greater than a predetermined value M, representing a maximum number of classification operations performed by the classifier before the classifier is retrained. When C is greater than M, block 722 retrains the classifier and resets the variable C to zero. After block 722 or block 720 when C is not greater than M, the process 700 returns control to block 702 to await the next test data set. The number of classifications M may be relatively large (e.g. >100) or may be variable such that the value M is initially small (e.g. 10) and increases as the classifier classifies more venues.

At block 704, when the process 700 determines that the test data set is not accompanied by connection data, control branches to off page connector B. Because there is no connection information associated with the test data set, the test data set was provided by a participant client device. As shown in FIG. 7B, the application 700, through connector B provides the test data set to the classifier at block 730 in which the classifier attempts to identify the venue based on the test data set. In block 730, the classifier returns a venue ID and a confidence value. At block 732, the process compares the confidence value to the threshold value. When the confidence value is less than the threshold value, the process 700, at block 734, determines whether the variable T is greater than N. When T is not greater than N, the process 700, at block 736, requests additional venue data from the participant client and increments the variable T. After block 736, the process returns control to block 732 to query the classifier based on the test data set and the additional data obtained in block 736. When, at block 734, the variable T is greater than N, the process 700, at block 738, requests and obtains ground truth data for the venue ID from the participant client device.

At block 740, the process 700 has determined the venue ID for the participant device. The process 700 then looks up the connection info for the venue ID and returns the connection information to the client device. After block 740, the application 700, at block 742, combines the venue ID with the test data set with any additional venue data and adds the combined data set to the training data for the classifier 224 and increments the variable C. After block 742, block 744 determines whether C is greater than M, that is to say whether the classifier has performed more than M classification operations. When C is greater than M, block 746 retrains the classifier and resets the variable C to zero. After block 746 or after block 744 when C is not greater than M, the application 700 returns control to block 702 via the off page connector A.

### Example 1

In one example, a central server includes a processor and a memory to store an application including executable instructions. The executable instructions cause the processor to receive a venue identification query from a client device in the venue and a test data set collected from the venue. The memory also stores the venue identifier (venue IDs) of the venue and connection information associated with the venue ID. The executable instructions cause the processor to query a classifier with the test data set to obtain the venue ID for the venue and a confidence value for the obtained venue ID. The classifier is an application, including executable instructions that runs on the server or on another device coupled to the server. When the confidence value provided by the classifier is less than a threshold value, the executable instructions cause the processor to obtain additional data from the venue until the venue ID is determined. The application associates the venue ID with the test data set combined with any additional data and adds the combined data set to training data for the classifier.

In one implementation, the obtaining of the additional data from the venue includes requesting and obtaining a further data set from the venue and querying the classifier with a combination of the test data set and additional data sets to obtain the venue ID and a further confidence value. The server obtains additional data sets and applies them to the classifier until the confidence value is greater than or equal to the threshold value.

In one implementation, the obtaining of the venue ID includes sending a ground truth request for the identity value and receiving the venue ID in response to the request.

In an implementation, the sending of the ground truth request for the venue ID includes sending a request for a device in the venue to emit an identity request signal and the receiving of the identity value includes receiving data emitted by a further device in the venue in response to the identity request signal.

In one implementation, the receiving of the test data set includes receiving from a device in the venue, data describing one or more received radio-frequency (RF) signals, data describing ambient audio signals in the venue, global navigation satellite system (GNSS) location data, meeting location data in a current calendar entry of the client device, data identifying a last known location of the client device and an elapsed time since the last known location was determined, time data, identity and status data for communication-enabled devices in the venue, environmental data for the venue, and/or image data captured by the client device.

In one embodiment, the classifier includes a support vector machine, a neural network, a multivariate Gaussian mixture model, and/or a hidden Markov model.

In one embodiment, the server is configured to process multiple venue identification queries and multiple data sets for the venue. Each processed data set is labeled with the venue ID and added to the training data as the data set. After a predetermined number of data sets have been added to the training data, the server is configured to retrain the classifier using the training data.

In one embodiment, the retraining includes applying respective weighting values to the multiple data sets such that older data sets have lower weighting values.

In one implementation, the connection information includes an Internet protocol (IP) address associated with the venue.

### Example 2

In another implementation, a client device obtains connection information for a venue by collecting ambient data from the venue and transmitting the ambient data to a central server with a request for the connection information. The client device, upon receiving a request for additional data from the central server generates the additional data identifying the venue and transmits the additional data to the central server. The client device then receives the connection information for the venue.

In one implementation, the client device collects the ambient data for the venue by collecting data identifying received radio-frequency (RF) signals received by the device, data describing ambient audio signals in the venue, global navigation satellite system (GNSS) location data for the client device, meeting location data in a current calendar entry of the client device, data identifying a last known location of the client device and an elapsed time since the last known location was determined, time data maintained by the client device, identity and status data for communication-enabled devices in venue, environmental data for the venue, and/or image data captured by the device.

In one implementation, the generating of the additional data includes emitting, by the device a short-range, signal and receiving a response to the short range signal from a further device in the venue, the response including the additional data.

In one implementation, the short-range signal and the response each an optical signal, an audio signal and/or a magnetic signal.

In one implementation, the short-range signal includes an ultrasonic query signal and the response includes an ultrasonic identification signal.

In one embodiment, the short-range signal includes a near-field communication (NFC) query signal and the response includes an NFC identification signal.

In one embodiment, the short-range signal includes an infrared (IR) query signal and the response include an IR identification signal.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the scope of the appended claims.

In particular and in regard to the various functions performed by the above described components, devices, circuits, systems and the like, the terms used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the disclosed example embodiments and implementations include a system as well as computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned example systems have been described with respect to interaction among several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

Furthermore, while a particular feature of the claimed subject matter may have been disclosed with respect to one of several implementations, such feature may be combined with one or more other features of the other implementations as may be desired and advantageous for any given or particular application. In addition, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

The invention claimed is:

1. A method for identifying a venue comprising:
receiving, at a central server, a venue identification query from a client device in the venue and a test data set collected from the venue;
querying a classifier with the test data set to obtain an identity value for the venue (venue ID) and a confidence value for the venue ID;
when the confidence value is less than a threshold value, obtaining additional data from the venue until the venue ID is determined; and
combining the determined venue ID with the test data set and with the further additional data to form a combined data set and adding the combined data set to training data for the classifier.

2. The method of claim 1 wherein:
the obtaining the additional data from the venue includes:
a) requesting a further data set from the venue;
b) receiving the further data set from the venue;
c) querying the classifier with a combination of the test and further data sets to obtain the identity value and a further confidence value;
d) incorporating the further data set into the test data set; and
e) repeating steps a), b), c) and d) until the confidence value is greater than or equal to the threshold value.

3. The method of claim 1 wherein:
the obtaining the venue ID includes:
sending a ground truth request for the venue ID; and
receiving the venue ID in response to the ground truth request.

4. The method of claim 3, wherein:
the sending of the ground truth request for venue ID includes sending a request for the client device to emit an identity request signal; and
the receiving of the identity value includes receiving data emitted by a further device in the venue in response to the identity request signal.

5. The method of claim 1 wherein:
the receiving of the test data set includes receiving from the client device at least one of:
data describing one or more received radio-frequency (RF) signals;
data describing ambient audio signals in the venue;
global navigation satellite system (GNSS) location data;
meeting location data in a current calendar entry of the client device;
data identifying a last known location of the client device and an elapsed time since the last known location was determined;
time data;
identity and status data for communication-enabled devices in the venue;
environmental data for the venue; or
image data captured by the client device

6. The method of claim 1, wherein the classifier includes at least one of:
a support vector machine;
a neural network;
a multivariate Gaussian mixture model; or
a hidden Markov model.

7. The method of claim 1, further comprising:
processing multiple venue identification queries and multiple data sets for the venue, each data set being added to the training data as the data set is processed; and
retraining the classifier using the training data when a predetermined number of data sets have been added to the training data.

8. The method of claim 7, wherein the retraining includes applying respective weighting values to the multiple data sets.

9. The method of claim 1, wherein the connection information includes an Internet protocol (IP) address associated with the venue.

10. A method for obtaining connection information for a venue comprising:
collecting, by a client device in the venue, ambient data from the venue;
transmitting, by the client device to a central server, a request for the connection information, the request including the collected ambient data;
receiving, from the central server, a request for additional data to identify the venue;
generating the additional data identifying the venue and transmitting the additional data to the central server;
receiving, from the central server, the connection information for the venue.

11. The method of claim 10, wherein the collecting ambient data from the venue includes collecting at least one of:
data identifying received radio-frequency (RF) signals received by the device;
data describing ambient audio signals in the venue;
global navigation satellite system (GNSS) location data for the client device;
meeting location data in a current calendar entry of the client device;
data identifying a last known location of the client device and an elapsed time since the last known location was determined;
time data maintained by the client device;
identity and status data for communication-enabled devices in venue;
environmental data for the venue; or
image data captured by the client device

12. The method of claim 10, wherein the generating of the additional data includes:
emitting, by the client device a short-range, signal; and
receiving a response to the short range signal from a further device in the venue, the response including the additional data.

13. The method of claim 12, wherein the each of the short-range signal and the response includes at least one of an optical signal, an audio signal or a magnetic signal.

14. The method of claim 12, wherein the short-range signal includes an ultrasonic query signal and the response includes an ultrasonic identification signal.

15. The method of claim 12, wherein the short-range signal includes a near-field communication (NFC) query signal and the response includes an NFC identification signal.

16. The method of claim 12, wherein the short-range signal includes an infrared (IR) query signal and the response include an IR identification signal.

17. Apparatus comprising:
a central server including a processor, a non-transitory memory storage device, a communications interface and an interface to a classifier, the storage device storing executable instructions that configure the processor to:
receive, via the communications interface, a venue identification query from a client device in the venue and a test data set collected from the venue;
query the classifier, via the classifier interface, with the test data set to obtain an identity value for the venue (venue ID) and a confidence value for the venue ID;
when the confidence value is less than a threshold value, obtain additional data from the venue until the venue ID is determined; and
combine the obtained venue ID with the test data set and with the additional data to form a combined data set and adding the combined data set to training data for the classifier.

18. The apparatus of claim 17 wherein the executable instructions that configure the processor to obtain the additional data from the venue further configure the processor to repeatedly:
request the additional data from the venue;
receive the additional data from the venue;
query the classifier with a combination of the test and additional data to obtain the identity value and a further confidence value; and
incorporate the additional data into the test data set;
until the confidence value is greater than or equal to the threshold value.

19. The apparatus of claim 17 wherein the executable instructions that configure the processor to obtain the additional data from the venue further configure the processor to:
send a ground truth request for the venue ID; and
receive the venue ID in response to the ground truth request.

20. The apparatus of claim 17, wherein the executable instructions that configure the processor to send the ground truth request further configure the processor to send a request for the client device to emit an identity request signal; and
the executable instructions that cause the processor to receive the venue ID further cause the processor to receive data emitted by a further device in the venue in response to the identity request signal.
